(19) United States
(12) Patent Application Publication
(10) Pub. No.: US 2023/0121196 A1
(43) Pub. Date: Apr. 20, 2023

(54) VEHICLE SEAT CLIMATE SYSTEMS

(71) Applicant: Lear Corporation, Southfield, MI (US)

(72) Inventors: Dinesh Kumar, Ginsheim-Gustavsburg (DE); Sven Auer, Ginsheim-Gustavsburg (DE); Adam Clark, Coventry (GB); Chad Weisgerber, Southfield, MI (US); Vyachislav Ivanov, West Bloomfield, MI (US); Yonas Tesfai, Ginsheim-Gustavsburg (DE)

(73) Assignee: Lear Corporation, Southfield, MI (US)

(21) Appl. No.: 17/960,192

(22) Filed: Oct. 5, 2022

(30) Foreign Application Priority Data
Oct. 18, 2021 (DE) 10 2021 126 924.5

(51) Int. Cl. B60N 2/56

(52) U.S. Cl. CPC B60N 2/5657

(57) ABSTRACT

An example seat climate system includes a seat, a first ventilation device, a second ventilation device, and a ventilation device controller. The seat has a first ventilation layer and a second ventilation layer. The first ventilation device is connected to the first ventilation layer and has an off state and an on state. The first ventilation device moves air through the first ventilation layer when in the on state. The second ventilation device is connected to the second ventilation layer and has an off state and an on state. The second ventilation device moves air through the second ventilation layer when in the on state. The ventilation device controller is connected to the first ventilation device and the second ventilation device and includes a controller and driver.

### RELATED APPLICATIONS

This application claims priority to German patent application No. 10 2021 126 924.5 filed Oct. 18, 2021, the entire disclosure of which is expressly incorporated herein by reference.

### FIELD

The disclosure relates generally to the field of vehicle seats. More particularly, the disclosure relates to vehicle seat climate systems.

### BACKGROUND

Conventional vehicle seats often include various components to increase the level of comfort for occupants of the seats. For example, ventilated seats have been developed that include a single fan or multiple fans on a seat cushion and a single fan or multiple fans on a seat backrest, each of which provides a mechanism for moving air through the vehicle seat in a single direction. To assist with controlling the fans, a printed circuit board assembly (PCBA), which includes a controller and driver, is included within each of the fan assemblies. Each PCBA is electrically connected to the seat and vehicle's electronic control unit (ECU) using seat wiring harnesses. Therefore, current vehicle seat climate systems include at least two PCBAs, two controllers, and two drivers.

A need exists, therefore, for new and useful vehicle seat climate systems.

### SUMMARY

Various example vehicle seat climate systems are described.

An example seat climate system includes a seat, a first ventilation device, a second ventilation device, and a ventilation device controller. The seat has a first ventilation layer and a second ventilation layer. The first ventilation device is connected to the first ventilation layer and has an off state and an on state. The first ventilation device moves air through the first ventilation layer when in the on state. The second ventilation device is connected to the second ventilation layer and has an off state and an on state. The second ventilation device moves air through the second ventilation layer when in the on state. The ventilation device controller is connected to the first ventilation device and the second ventilation device and includes a controller and driver.

Additional understanding of these examples can be obtained by review of the detailed description, below, and the appended drawings.

### BRIEF DESCRIPTION OF THE DRAWINGS

FIG. 1 is a sectional view of a first prior art vehicle seat.

FIG. 2 is a sectional view of a second prior art vehicle seat.

FIG. 3 is a schematic diagram of the first and second prior art vehicle seats shown in FIGS. 1 and 2.

FIG. 4 is a sectional view of a first embodiment of a vehicle seat climate system.

FIG. 5 is a top view of a ventilation layer of the vehicle seat climate system illustrated in FIG. 4.

FIG. 6 is an elevation view of a ventilation device of the vehicle seat climate system illustrated in FIG. 4.

FIG. 7 is a schematic diagram of the vehicle seat climate system illustrated in FIG. 4.

FIG. 8 is a sectional view of a second embodiment of a vehicle seat climate system.

FIG. 9 is a top view of a ventilation layer of the vehicle seat climate system illustrated in FIG. 8.

FIG. 10 is a perspective view of a third embodiment of a vehicle seat climate system.

FIG. 11 is a top view of ventilation layers of the vehicle seat climate system illustrated in FIG. 10.

FIG. 12 is a perspective view of the ventilation layers illustrated in FIG. 11.

FIG. 13 is a sectional view of the ventilation layers illustrated in FIG. 11.

FIG. 14 is a sectional view of a fourth embodiment of a vehicle seat climate system.

FIG. 15 is a sectional view of a fifth embodiment of a vehicle seat climate system.

FIG. 16 is a perspective view of a ventilation layer of the vehicle seat climate system illustrated in FIG. 15.

FIG. 17 is another perspective view of the ventilation layer illustrated in FIG. 16.

FIG. 18 is a sectional view of a sixth embodiment of a vehicle seat climate system.

FIG. 19 is a sectional view of a seventh embodiment of a vehicle seat climate system.

FIG. 20 is a sectional view of an eighth embodiment of a vehicle seat climate system.

### DETAILED DESCRIPTION

The following detailed description and the appended drawings describe and illustrate various example vehicle seat climate systems. The description and illustration of these examples are provided to enable one skilled in the art to make and use a vehicle seat climate system according to this invention. They are not intended to limit the scope of the claims in any manner.

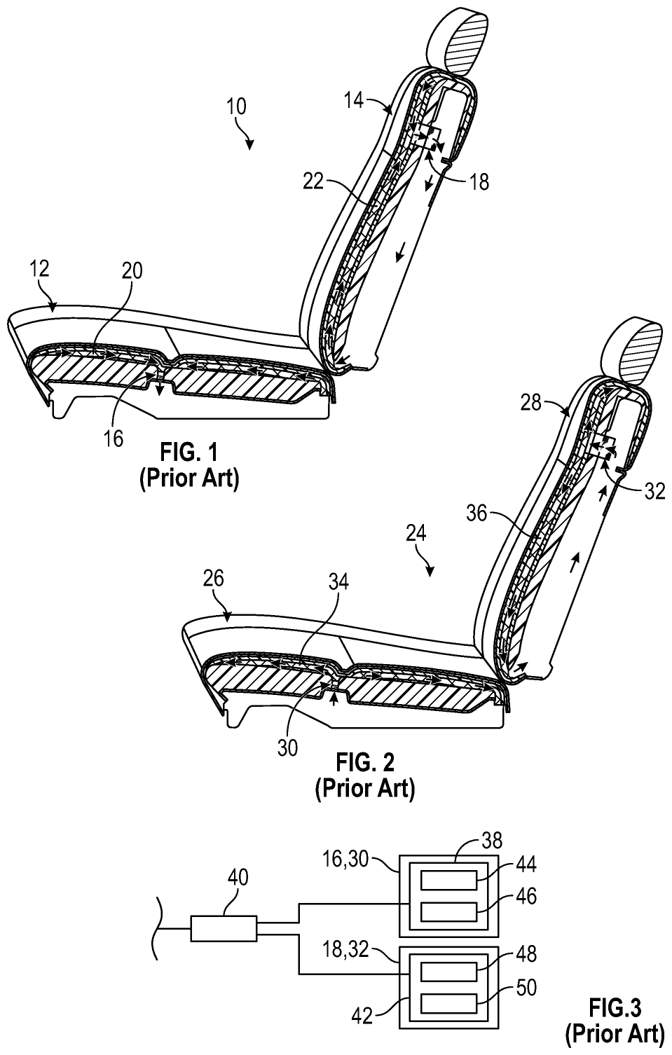

Two example conventional vehicle seats 10, 24 are shown in FIGS. 1 and 2. With respect to FIG. 1, a conventional vehicle seat 10 includes a seat cushion 12, a seat backrest 14, a first fan 16, and a second fan 18. The first fan 16 is disposed on the seat cushion 12 and is in communication with a cushion layer 20 such that suction is applied to the cushion layer 20 when the first fan 16 is in an on state. The second fan 18 is disposed on the seat backrest 14 and is in communication with a backrest layer 22 such that suction is applied to the backrest layer 22 when the second fan 20 is in an on state. With respect to FIG. 2, another conventional vehicle seat 24 includes a seat cushion 26, a seat backrest 28, a first fan 30, and a second fan 32. The first fan 30 is disposed on the seat cushion 26 and is in communication with a cushion layer 34 such that air is blown into the cushion layer 34 when the first fan 30 is in an on state. The second fan 32 is disposed on the seat backrest 28 and is in communication with a backrest layer 36 such that air is blown into the backrest layer 36 when the second fan 32 is in an on state. The cushion layers 20, 34 and backrest layers 22, 36 can be a spacer material, a ventilation mat, or diffuser channels, which can be attached or glued on an A-side or B-side of a seat cushion foam or a seat backrest foam.

As shown in FIG. 3, each of the first fans 16, 30 includes a first PCBA 38 that is directly electrically connected to the seat or vehicle's ECU 40. In addition, each of the second fans 18, 32 includes a second PCBA 42 that is directly electrically connected to the seat or vehicle's ECU 40. The first PCBA 38 includes a first controller 44 and a first driver 46 and the second PCBA 42 includes a second controller 48 and a second driver 50. Therefore, two PCBA's 38, 42, two controllers 44, 48, and two drivers 46, 50 are included in each of the conventional vehicle seats 10, 24. Moreover, the structural arrangement of conventional vehicle seats 10, 24 only allows movement of air through the layers 20, 22, 34, 36 in one direction when in use.

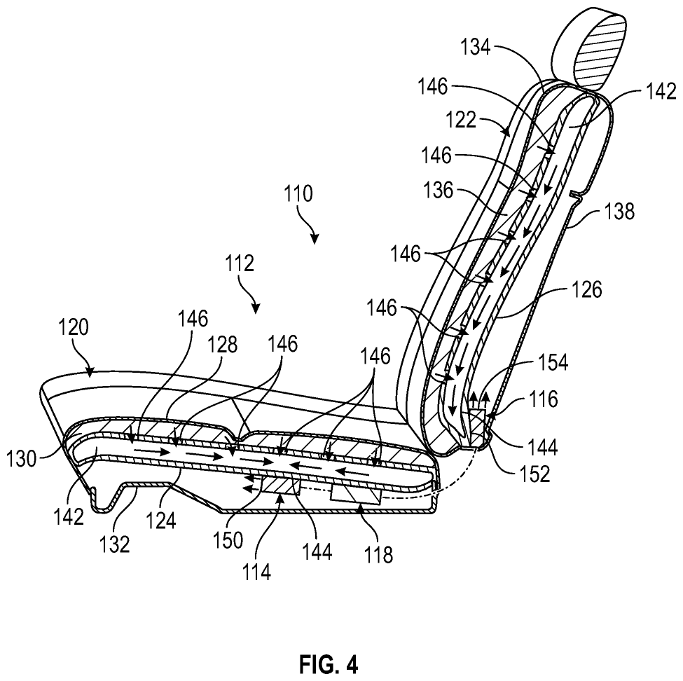

FIGS. 4, 5, 6, and 7 illustrate a first embodiment of a vehicle seat climate system 110 that includes a vehicle seat 112, a first ventilation device 114, a second ventilation device 116, and a ventilation device controller 118.

The vehicle seat 112 has a first seat component 120, a second seat component 122, a first ventilation layer 124, and a second ventilation layer 126. The second seat component 122 is disposed adjacent to the first seat component 120. The first seat component 120 has a first trim 128, a first cushion portion 130, and a first frame 132. The second seat component 122 has a second trim 134, a second cushion portion 136, and a second frame 138. Each of the first trim 128, the first cushion portion 130, the second trim 134, and the second cushion portion 136 is formed of an air permeable material. A first cushion portion and a second cushion portion can be formed of any suitable material and have any suitable structural arrangement. For example, a first cushion portion can be formed of a non-permeable material and/or define one or more passageways that provide air flow to a first trim and/or a second cushion portion can be formed of a non-permeable material and/or define one or more passageways that provide air flow to a second trim.

In the illustrated embodiment, the first ventilation layer 124 is disposed on the first seat component 120 and the second ventilation layer 126 is disposed on the second seat component 122. The first ventilation layer 124 is disposed between the first cushion portion 130 and the first frame 132 and the second ventilation layer 126 is disposed between the second cushion portion 136 and the second frame 138. However, in alternative embodiments a first ventilation layer can be disposed between a first trim and a first cushion portion and/or a second ventilation layer can be disposed between a second trim and a second cushion portion. A seat component included in a vehicle seat can comprise any suitable seat component having any suitable structural configuration and selection of a suitable seat component can be based on various considerations, such as the intended use of a vehicle seat climate system. Examples of seat components considered suitable to include in a vehicle seat climate system include seat cushions, seat backrests, seat headrests, seat armrests, and any other seat component considered suitable for a particular embodiment. In the embodiment illustrated, the first seat component 120 is a seat cushion and the second seat component 122 is a seat backrest.

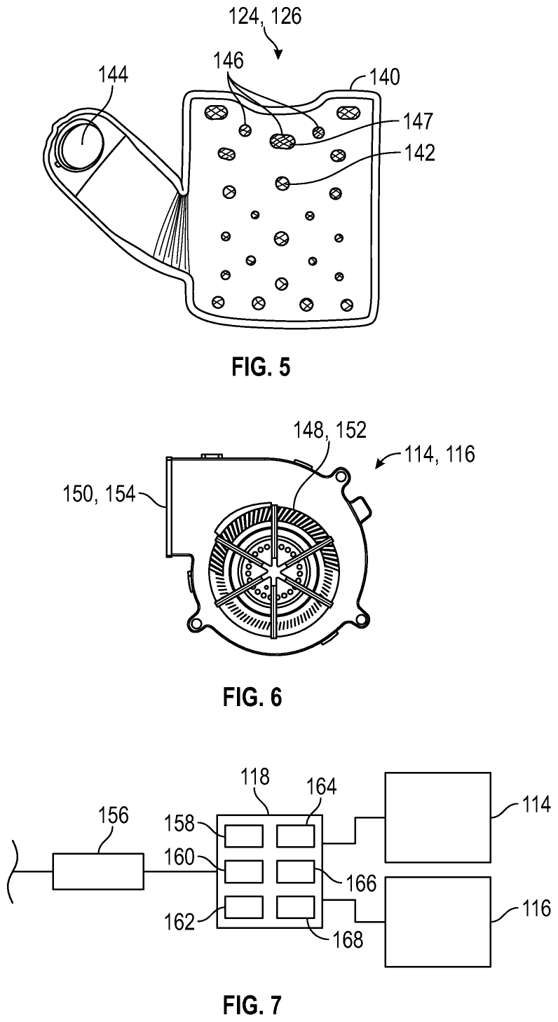

As shown in FIG. 5, each of the first ventilation layer 124 and the second ventilation layer 126 comprises a housing 140 that defines a chamber 142, a port 144, and a plurality of openings 146. The port 144 is in fluid communication with the chamber 142 such that air can pass through the port 144 and into the chamber 142, and vice versa. The housing 140 is formed of a non-permeable material such that air can only flow through the plurality of openings 146. While the port 144 has been illustrated in a particular location on the ventilation layers 124, 126, a port can be positioned at any suitable location on a ventilation layer. For example, alternative to the arrangement illustrated in FIG. 5, a port can be included on a ventilation layer without an elongated arm. Each opening of the plurality of openings 146 is also in fluid communication with the chamber 142 such that air can pass through each opening of the plurality of openings 146 and into the chamber 142, and vice versa. In the illustrated embodiment, a spacer material 147 (e.g., air diffuser material, air permeable material) is disposed within, and covers, each opening of the plurality of openings 146. However, in alternative embodiments, a spacer material can be omitted or substituted with other structure, such as an air permeable member or ring member formed of any suitable material (e.g., rubber or plastic chambers), as described in more detail herein, or any other air permeable material. While the first ventilation layer 124 and the second ventilation layer 126 have been illustrated as having a particular structural arrangement, a ventilation layer included in a vehicle seat climate system can have any suitable structural arrangement (e.g., width, length), define any suitable number of openings, and can be attached to any suitable portion of a seat component (e.g., trim, cushion portion, frame) using any suitable method or technique (e.g., glue, mechanical fasteners). For example, a ventilation layer can have a width that is greater than, less than, or equal to a width of a seat component of which the ventilation layer is a component and/or a length that is greater than, less than, or equal to a length of a seat component of which the ventilation layer is a component. Alternative embodiments can include a ventilation layer that comprises a layer of air permeable material that omits the inclusion of a chamber, a port, and a plurality of openings. In addition, alternative embodiments can include a seat component that includes a cushion portion that defines a plurality of passageways that extend from a first surface in contact with a ventilation layer to a second surface in contact with a trim. In this alternative embodiment, each passageway of the plurality of passageways can be aligned with (e.g., coaxial) an opening of a plurality of openings defined by a ventilation layer to accomplish movement of air, as described herein.

The first ventilation device 114 is connected to the first ventilation layer 124 and has an off state and an on state. In the illustrated embodiment, the first ventilation device 114 is connected to the port 144 of the first ventilation layer 124. However, in alternative embodiments, a ventilation device can be attached to any suitable portion of a ventilation layer. The first ventilation device 114 moves air through the first ventilation layer 124 when in the on state and does not move air through the first ventilation layer 124 when in the off state. FIG. 6 illustrates an example first ventilation device 114 that can be included in a vehicle seat climate system 110. The first ventilation device 114 has a suction port 148 connected to the first ventilation layer 124 and a discharge port 150. In the illustrated embodiment, air enters the suction port 148 from the first ventilation layer 124 and air exits the discharge port 150 when the first ventilation device 114 is in the on state. When the first ventilation device 114 is in the on state, suction is applied to the chamber 142 of the first ventilation layer 124 such that air passes through the first trim 128, the first cushion portion 130, the plurality of openings 146 of the first ventilation layer 124, into the chamber 142 of the first ventilation layer 124, and into the suction port 148. The first ventilation device 114 does not include a PCBA. Rather, the first ventilation device 114 only includes the components necessary to move air through the first ventilation layer 124 (e.g., a fan).

The second ventilation device 116 is connected to the second ventilation layer 126 and has an off state and an on state. In the illustrated embodiment, the second ventilation device 116 is connected to the port 144 of the second ventilation layer 126. The second ventilation device 116 moves air through the second ventilation layer 126 when in the on state and does not move air through the second ventilation layer 126 when in the off state. FIG. 6 illustrates an example second ventilation device 116 that can be included in a vehicle seat climate system 110. The second ventilation device 116 has a suction port 152 connected to the second ventilation layer 126 and a discharge port 154. In the illustrated embodiment, air enters the suction port 152 from the second ventilation layer 126 and air exits the discharge port 154 when the second ventilation device 116 is in the on state. When the second ventilation device 116 is in the on state, suction is applied to the chamber 142 of the second ventilation layer 126 such that air passes through the second trim 134, the second cushion portion 136, the plurality of openings 146 of the second ventilation layer 126, into the chamber 142 of the second ventilation layer 126, and into the suction port 152. The second ventilation device 116 does not include a PCBA. Rather, the second ventilation device 116 only includes the components necessary to move air through the second ventilation layer 126 (e.g., a fan).

A ventilation device can comprise any suitable component capable of moving air through a ventilation layer and selection of a suitable component can be based on various considerations, including the structural arrangement of a ventilation layer. Examples of ventilation devices considered suitable to include in a vehicle seat climate system include fans, such as radial fans, radial vent fans, axial fans, double outlet fans, blowers, three-phase sensorless blowers, and any other ventilation device considered suitable for a particular embodiment. While the vehicle seat climate system 110 has been illustrated as including a first ventilation device 114, a second ventilation device 116, a first ventilation layer 124, and a second ventilation layer 126, alternative embodiments can omit a ventilation device and/or ventilation layer on a seat component.

As shown in FIGS. 4 and 7, the ventilation device controller 118 (e.g., PCBA) is directly electrically connected to the first ventilation device 114, the second ventilation device 116, and an ECU 156 (e.g., vehicle ECU, seat ECU). In the illustrated embodiment, the ventilation device controller 118 includes a reverse voltage protection circuit 158, an electromagnetic compatibility (EMC) filter 160, a load dump circuit 162, a pulse-width modulation (PCM) interface, local interconnected network (LIN) interface, or a controller area network interface (CAN) 164, a controller 166, and an application specific integrated circuit (ASIC) driver 168. Optionally, a ventilation device controller 118 can allow for use of two, or more than two, ventilation devices at a time. For example, in FIGS. 4 and 7, ventilation device controller 118 allows for use of the first ventilation device 114 and the second ventilation device 116 at the same time. Alternatively, a ventilation device controller can allow for use of one ventilation device at a time (e.g., first ventilation device 114, second ventilation device 116). While the ventilation device controller 118 has been illustrated as including particular components, a ventilation device controller can include any suitable number and type of components, can omit some of the components described herein, can be positioned on any suitable portion of a system, and/or can have any suitable structural arrangement. For example, a PCBA included in a vehicle seat climate system can be a single layer PCBA, a multi-layer PCBA, be positioned within a first ventilation device, be positioned within a second ventilation device, be positioned within an environment exterior to the first and second ventilation devices, and/or include one or more resistors, capacitors, microchips, processors, and/or electronic communication devices. Optionally, a fan control module, temperature control module, and/or a memory module can be integrated into an ECU (e.g., vehicle ECU, seat ECU) and adapted to communication with a first ventilation device and/or second ventilation device. In the illustrated embodiment, only the ventilation device controller 118 includes a controller 166 and driver 168. Neither of the first ventilation device 114 or the second ventilation device 116 includes a controller or a driver.

The inclusion of a ventilation device controller 118, as described herein, is considered advantageous at least because it reduces the total number of electronic components included in a vehicle seat climate system. For example, in conventional systems, as described with respect to FIGS. 1-3, each fan includes a PCBA, which includes a controller and a driver. Therefore, two PCBA's, two controllers, and two drivers are included in conventional vehicle seat climate systems. In the embodiment illustrated in FIGS. 4 through 7, the vehicle seat climate system 110 includes a single controller 166 and driver 168, reducing the overall costs and complexity of the vehicle seat climate system 110.

While FIG. 4 illustrates the first ventilation device 114 as being connected to the first ventilation layer 124 in a particular manner and the second ventilation device 116 as being connected to the second ventilation layer 126 in a particular manner, a ventilation device can be connected to a ventilation layer in any suitable manner. For example, in an alternative embodiment a discharge port of a ventilation device can be connected to a ventilation layer such that air is blown into the ventilation layer. In addition, while FIG. 4 illustrates the first ventilation layer 124 as being positioned at a particular location on the first seat component 120 and the second ventilation layer 126 being positioned at a particular location on the second seat component 122, a ventilation layer can be positioned at any suitable location on a vehicle seat component. For example, a first ventilation layer can alternatively be positioned between a first trim and a first cushion and/or a second ventilation layer can alternatively be positioned between a second trim and a second cushion. Optionally, a cushion portion included in a vehicle seat climate system can include one or more passageways that extend through the thickness of the cushion portion such that air can travel through the passageways to a ventilation layer or from a ventilation layer to a seat trim.

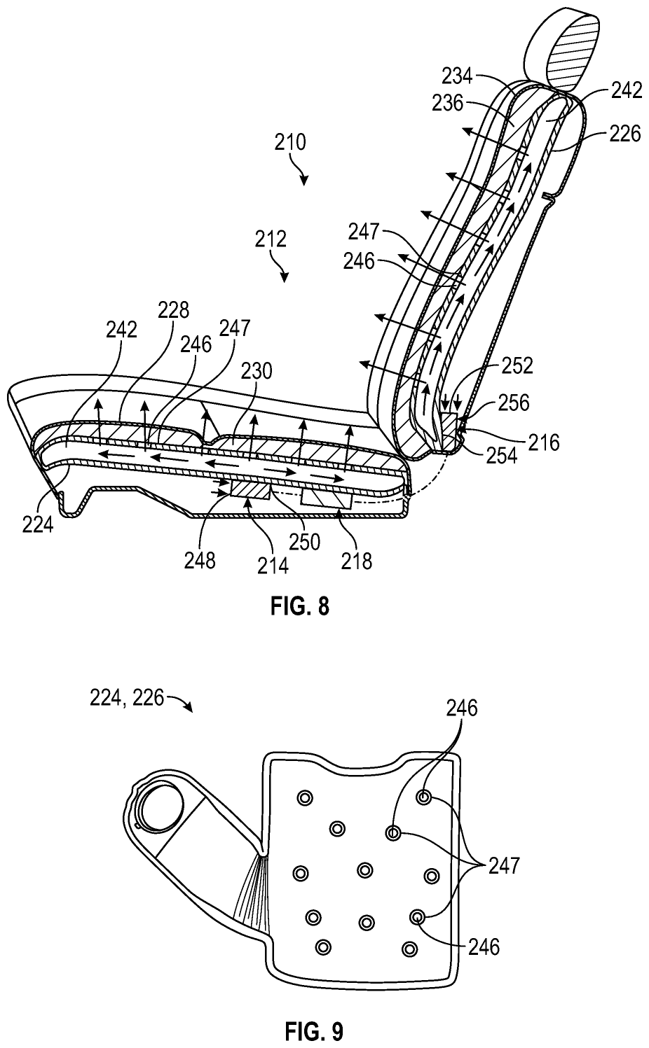

FIGS. 8 and 9 illustrate a second embodiment of a vehicle seat climate system 210 that includes a vehicle seat 212, a first ventilation device 214, a second ventilation device 216, and a ventilation device controller 218.

In the embodiment illustrated, an air permeable member 247 (e.g., rubber or plastic ring member, rubber or plastic chamber) is disposed within each opening of the plurality of openings 246 of the first ventilation layer 224 and the second ventilation layer 226 that directs air toward the relative seat trim 228, 234. However, in alternative embodiments, an air permeable member can be omitted or substituted with a spacer material. The first ventilation device 214 is connected to the first ventilation layer 224 and the second ventilation device 216 is connected to the second ventilation layer 226. Air enters the suction port 248 of the first ventilation device 214 and air exits the discharge port 250 into the first ventilation layer 224 when the first ventilation device 214 is in the on state. Air enters the suction port 252 of the second ventilation device 216 and air exits the discharge port 254 into the second ventilation layer 226 when the second ventilation device 216 is in the on state. When the first ventilation device 214 is in the on state, air is blown into the chamber 242 of the first ventilation layer 224 such that air passes through the plurality of openings 246 of the first ventilation layer 224, the first cushion portion 230, the first trim 228, and toward an environment in which an occupant can be positioned. In addition, when the second ventilation device 216 is in the on state, air is blown into the chamber 242 of the second ventilation layer 226 such that air passes through the plurality of openings 246 of the second ventilation layer 226, the second cushion portion 236, the second trim 234, and toward an environment in which an occupant can be positioned.

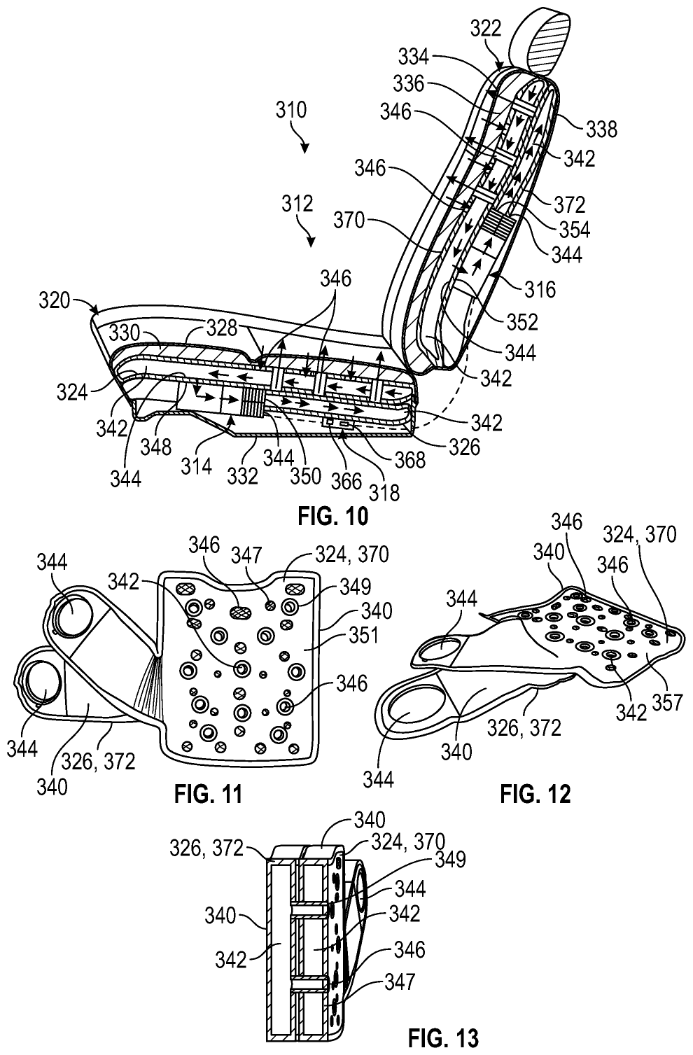

FIGS. 10, 11, 12, and 13 illustrate a third embodiment of a vehicle seat climate system 310 that includes a vehicle seat 312, a first ventilation device 314, a second ventilation device 316, and a ventilation device controller 318.

In the illustrated embodiment, the vehicle seat 312 has a first seat component 320, a second seat component 322, a first ventilation layer 324, a second ventilation layer 326, a third ventilation layer 370, and a fourth ventilation layer 372. The first seat component 320 has a first trim 328, a first cushion portion 330, and a first frame 332. The second seat component 322 has a second trim 334, a second cushion portion 336, and a second frame 338. The first ventilation layer 324 and the second ventilation layer 326 are disposed on the first seat component 320 and directly contact one another. In addition, the third ventilation layer 370 and the fourth ventilation layer 372 are disposed on the second seat component 322 and directly contact one another. However, in alternative embodiments, a first ventilation layer and second ventilation layer can be separated such that they do not directly contact one another and/or a third ventilation layer and fourth ventilation layer can be separated such that they do not directly contact one another. The first ventilation layer 324 and the second ventilation layer 326 are disposed between the first cushion portion 330 and the first frame 332 and the third ventilation layer 370 and the fourth ventilation layer 372 are disposed between the second cushion portion 336 and the second frame 338. However in alternative embodiments, a first ventilation layer and a second ventilation layer can be disposed between a first trim and a first cushion portion and/or a third ventilation layer and a fourth ventilation layer can be disposed between a second trim and a second cushion portion.

As shown in FIGS. 11, 12, and 13, each of the first ventilation layer 324, the second ventilation layer 326, the third ventilation layer 370, and the fourth ventilation layer 372 comprises a housing 340 that defines a chamber 342, a port 344, and a plurality of openings 346. The port 344 is in fluid communication with the chamber 342 such that air can pass through the port 344 and into the chamber 342, and vice versa. Each opening of the plurality of openings 346 is also in fluid communication with the chamber 342 such that air can pass through each opening of the plurality of openings 346 and into the chamber 342, and vice versa. In the illustrated embodiment, a spacer material 347 covers each opening of the plurality of openings 346 of the first ventilation layer 324 and the third ventilation layer 370 and an air permeable member 349 is disposed within each opening of the plurality of openings 346 of the second ventilation layer 326 and the fourth ventilation layer 372. Each air permeable member 349 of the second ventilation layer 326 extend from the second ventilation layer 326, through the first ventilation layer 324, and are disposed on a surface 351 of the first ventilation layer 324 such that the plurality of openings 346 of the first ventilation layer 324 and the second ventilation layer 326 are disposed on the surface 351. In addition, each air permeable member 349 of the fourth ventilation layer 372 extend through the third ventilation layer 370 and are disposed on a surface 351 of the third ventilation layer 370 such that the plurality of openings 346 of the third ventilation layer 370 and the fourth ventilation layer 372 are disposed on the surface 351. The first ventilation layer 324 is isolated from the second ventilation layer 326 and the third ventilation layer 370 is isolated from the fourth ventilation layer 372. While a spacer material and air permeable members have been illustrated, in alternative embodiments a spacer material and/or air permeable member can be omitted or substituted with any other suitable structure or process to isolate a first ventilation layer from a second ventilation and/or a third ventilation layer from a fourth ventilation layer.

The first ventilation device 314 is connected to the first ventilation layer 324 and the second ventilation layer 326 and has an off state and an on state. In the illustrated embodiment, the first ventilation device 314 is connected to the port 344 of the first ventilation layer 324 and the port 344 of the second ventilation layer 326. The first ventilation device 314 moves air through the first ventilation layer 324 and the second ventilation layer 326 when in the on state and does not move air through the first ventilation layer 324 and the second ventilation layer 326 when in the off state. The first ventilation device 314 has a suction port 348 connected to the first ventilation layer 324 and a discharge port 350 connected to the second ventilation layer 326. In the illustrated embodiment, air enters the suction port 348 from the first ventilation layer 324 and air exits the discharge port 350 into the second ventilation layer 326 when the first ventilation device 314 is in the on state. When the first ventilation device 314 is in the on state, suction is applied to the chamber 342 of the first ventilation layer 324 such that air passes through the first trim 328, the first cushion portion 330, the plurality of openings 346 of the first ventilation layer 324, into the chamber 342 of the first ventilation layer 324, and into the suction port 348. In addition, when the first ventilation device 314 is in the on state, air is blown into the chamber 342 of the second ventilation layer 326 such that air passes through the plurality of openings 346 of the second ventilation layer 326, the first cushion portion 330, the first trim 328, and toward an environment in which an occupant can be positioned. The first ventilation device 314 does not include a PCBA. Rather, only the components necessary to move air through the first ventilation layer 324 and the second ventilation layer 326 are included in the first ventilation device 314 (e.g., a fan).

The second ventilation device 316 is connected to the third ventilation layer 370 and the fourth ventilation layer 372 and has an off state and an on state. In the illustrated embodiment, the second ventilation device 316 is connected to the port 344 of the third ventilation layer 370 and the port 344 of the fourth ventilation layer 372. The second ventilation device 316 moves air through the third ventilation layer 370 and the fourth ventilation layer 372 when in the on state and does not move air through the third ventilation layer 370 and the fourth ventilation layer 372 when in the off state. The second ventilation device 316 has a suction port 352 connected to the third ventilation layer 370 and a discharge port 354 connected to the fourth ventilation layer 372. In the illustrated embodiment, air enters the suction port 352 from the third ventilation layer 370 and air exits the discharge port 354 into the fourth ventilation layer 372 when the second ventilation device 316 is in the on state. When the second ventilation device 316 is in the on state, suction is applied to the chamber 342 of the third ventilation layer 370 such that air passes through the second trim 334, the second cushion portion 336, the plurality of openings 346 of the third ventilation layer 370, into the chamber 342 of the third ventilation layer 370, and into the suction port 352. In addition, when the second ventilation device 316 is in the on state, air is blown into the chamber 342 of the fourth ventilation layer 372 such that air passes through the plurality of openings 346 of the fourth ventilation layer 372, the second cushion portion 336, the second trim 334, and toward an environment in which an occupant can be positioned. The second ventilation device 316 does not include a PCBA. Rather, only the components necessary to move air through the third ventilation layer 370 and fourth ventilation layer 372 are included in the second ventilation device 316 (e.g., a fan).

While the vehicle seat climate system 310 has been illustrated as including a first ventilation device 314, a second ventilation device 316, a first ventilation layer 324, a second ventilation layer 326, a third ventilation layer 370, and a fourth ventilation layer 372, alternative embodiments can omit a ventilation device and/or one or more ventilation layers. Optionally, an occupant switch (e.g., control knob) and/or automation can be used to control the operation of a ventilation device included in a vehicle seat climate system. For example, automation can be utilized to move a ventilation device from an on state to an off state after a pre-defined period of time has lapsed, move a ventilation device from an on state to an off state after a pre-defined temperature has been reached, and/or to control a speed at which a ventilation device operates. In addition, an occupant can move a ventilation device between on and off states, or between various speeds (e.g., low, medium, high), using a switch.

The ventilation device controller 318 is similar to the ventilation device controller 118, described above. For example, in the illustrated embodiment, the ventilation device controller 318 is connected to the first ventilation device 314, the second ventilation device 316, and the seat or vehicle ECU and only the ventilation device controller 318 includes a controller 366 and driver 368. Neither of the first ventilation device 314 or the second ventilation device 316 includes a controller or a driver. While each of the first ventilation device 314 and the second ventilation device 316 have been illustrated as connected to the ventilation device controller 318, alternative embodiments can omit the inclusion of a ventilation device controller such that each of a first ventilation device and a second ventilation device includes a controller and a driver and is directly connected to a seat or vehicle ECU. Alternatively, a ventilation device controller can be included in a first ventilation device and be directly connected to a seat or vehicle ECU and communication with a second ventilation device, which omits the inclusion of a ventilation device controller. Alternatively, a ventilation device controller can be included in a second ventilation device and be directly connected to a seat or vehicle ECU and communication with a first ventilation device, which omits the inclusion of a ventilation device controller.

While FIG. 10 illustrates the first ventilation device 314 as being connected to the first ventilation layer 324 and the second ventilation layer 326 in a particular manner and the second ventilation device 316 as being connected to the third ventilation layer 370 and the fourth ventilation layer 372 in a particular manner, a ventilation device can be connected to a ventilation layer in any suitable manner. For example, a suction port of a ventilation device can be connected to a second ventilation layer and/or a fourth ventilation layer such that suction can be applied to the ventilation layers and/or a discharge port of a ventilation device can be connected to a first ventilation layer and/or a third ventilation layer such that air can be blown into the ventilation layers. In addition, while FIG. 10 illustrates the first ventilation layer 324 and the second ventilation layer 326 as being positioned at a particular location on the first seat component 320 and the third ventilation layer 370 and the fourth ventilation layer 372 as being positioned at a particular location on the second seat component 322, a ventilation layer can be positioned at any suitable location on a vehicle seat component. For example, a first ventilation layer and a second ventilation layer can alternatively be positioned between a first trim and a first cushion and/or a third ventilation layer and a fourth ventilation layer can alternatively be positioned between a second trim and a second cushion. While each of the first seat component and the second seat component have been illustrated as including a ventilation device and ventilation layers, alternative embodiments can include a seat portion that omits the inclusion of a ventilation device and ventilation layers.

Optionally, a vehicle seat climate system can include a cooling device and/or heating device to provide additional climate control. A cooling device can comprise any device capable of decreasing the temperature of a fluid, such as air, and/or surrounding materials and a heating device can comprise any device capable of increasing the temperature of a fluid, such as air, and/or surrounding materials. A cooling device and/or heating device can be positioned at any suitable location within a vehicle seat climate system. Examples of cooling devices and heating devices considered suitable to include in a vehicle seat climate system include thermoelectric devices, such as Peltier devices, heating mats, and any other devices considered suitable for a particular embodiment. In embodiments in which a heating mat is included in a vehicle seat climate system, the heating mat can be positioned at any suitable location within the vehicle seat climate system, such as between trim and a cushion portion, between trim and a ventilation layer, between a cushion portion and a ventilation layer, and/or between a cushion portion and a frame. Alternatively, in embodiments in which thermoelectric devices, such as Peltier devices, are included in a vehicle seat, the thermoelectric devices can be positioned at any suitable location within a vehicle seat climate system, such as within, or adjacent to, a suction port and/or discharge port of a ventilation device. Optionally, a heating mat can be used in combination with a thermoelectric device.

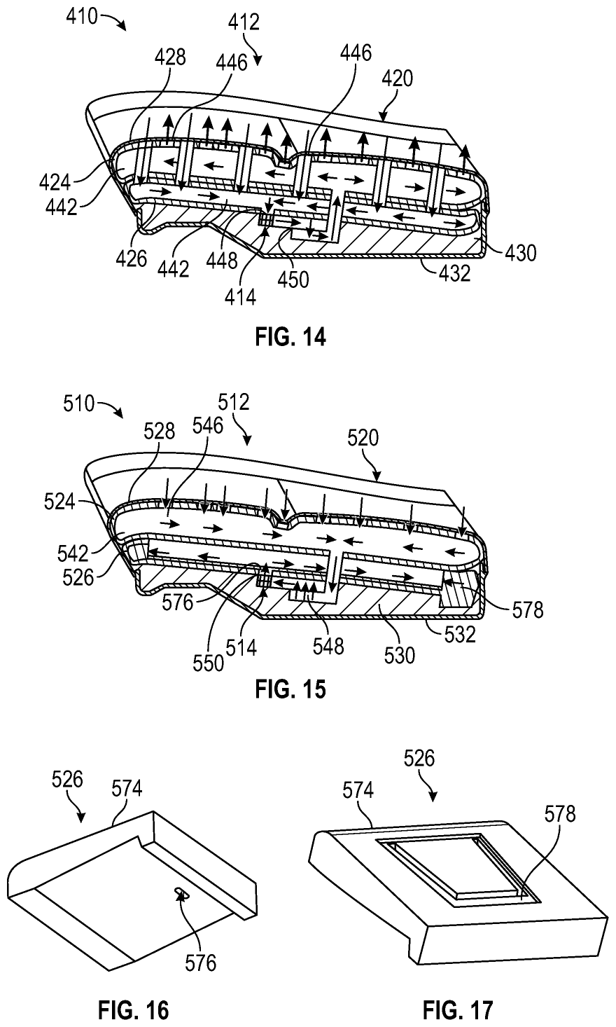

FIG. 14 illustrates a fourth embodiment of a vehicle seat climate system 410 that includes a vehicle seat 412 and a first ventilation device 414. In the illustrated embodiment, the vehicle seat 412 has been illustrated as including a first seat component 420 for clarity. However, a vehicle seat can include a second seat component, as described herein, which can optionally include the structure described with respect to the first seat component 420.

In the illustrated embodiment, the vehicle seat 412 has a first seat component 420, a first ventilation layer 424, and a second ventilation layer 426. The first seat component 420 has a first trim 428, a first cushion portion 430, and a first frame 432. In the illustrated embodiment, the first ventilation layer 424 and the second ventilation layer 426 are disposed on the first seat component 420. The first ventilation layer 424 and the second ventilation layer 426 are disposed between the first trim 428 and the first cushion portion 430. The first ventilation layer 424 is isolated from the second ventilation layer 426. In an alternative embodiment, a first ventilation layer and a second ventilation layer can be disposed between a first cushion portion and a first frame and/or a first cushion portion can define a plurality of passageways each of which is in communication with an opening defined by a first ventilation layer or a second ventilation layer.

In the embodiment illustrated, the first ventilation device 414 is connected to the first ventilation layer 424 and the second ventilation layer 426. When the first ventilation device 414 is in the on state, air enters the suction port 448 from the second ventilation layer 426 and air exits the discharge port 450 into the first ventilation layer 424. When the first ventilation device 414 is in the on state, suction is applied to the chamber 442 of the second ventilation layer 426 such that air passes through the first trim 428, the plurality of openings 446 of the second ventilation layer 426, into the chamber 442 of the second ventilation layer 426, and into the suction port 448. In addition, when the first ventilation device 414 is in the on state, air is blown into the chamber 442 of the first ventilation layer 424 such that air passes through the plurality of openings 446 of the first ventilation layer 424, the first trim 428, and toward an environment in which an occupant can be positioned. In embodiments in which a second seat component is included in vehicle seat climate system 410 that includes the structure described with respect to the first seat component 420, the vehicle seat climate system 410 can optionally include a ventilation device controller, as described herein, attached to the first ventilation device 414 included on the first seat component 420 and a second ventilation device included on the second seat component. When included, a ventilation device controller can be isolated and placed at any suitable location, such as within a ventilation device, a seat ECU, a vehicle ECU, or any other location within a seat or exterior to a seat.

FIGS. 15, 16, and 17 illustrate a fifth embodiment of a vehicle seat climate system 510 that includes a vehicle seat 512 and a first ventilation device 514. In the illustrated embodiment, the vehicle seat 512 has been illustrated as including a first seat component 520 for clarity. However, a vehicle seat can include a second seat component, as described herein, which can optionally include the structure described with respect to the first seat component 520.

In the illustrated embodiment, the vehicle seat 512 has a first seat component 520, a first ventilation layer 524, and a second ventilation layer 526. The first seat component 520 has a first trim 528, a first cushion portion 530, and a first frame 532. The first ventilation layer 524 and the second ventilation layer 526 are disposed on the first seat component 520. The first ventilation layer 524 and the second ventilation layer 526 are disposed between the first trim 528 and the first cushion portion 530. The first ventilation layer 524 is isolated from the second ventilation layer 526.

As shown in FIGS. 16 and 17, the second ventilation layer 526 comprises a foam layer 574 that defines a passageway 576 and a channel 578. The passageway 576 is in direct fluid communication with the channel 578 such that air can pass through the passageway 576 and into the channel 578. The channel 578 is directed toward the first ventilation layer 524 and the passageway 576 is directed toward the discharge port 550 of the first ventilation device 514. While the foam layer 574 has been illustrated as defining a single passageway 576 and a single channel 578, a foam layer can define any suitable structural configuration having any suitable number of passageways and/or channels. For example, alternative to defining a channel, a foam layer can define a plurality of openings in communication with the passageway. In addition, while the first ventilation layer 524 has been illustrated as defining a particular structural arrangement, any ventilation layer included in a vehicle seat climate system can include a foam layer, as described herein, and/or a second ventilation layer can include a ventilation layer, as described herein.

The first ventilation device 514 is connected to the first ventilation layer 524 (e.g., passageway 576) and the second ventilation layer 526. When the first ventilation device 514 is in the on state, air enters the suction port 548 from the first ventilation layer 524 and air exits the discharge port 550 into the second ventilation layer 526 such that the air initially passes through the passageway 576 and then into the channel 578 of the foam layer 574. When the first ventilation device 514 is in the on state, suction is applied to the chamber 542 of the first ventilation layer 524 such that air passes through the first trim 528, the plurality of openings 546 of the first ventilation layer 524, into the chamber 542 of the first ventilation layer 524, and into the suction port 548. In addition, when the first ventilation device 514 is in the on state, air is blown into the passageway 576 of the second ventilation layer 526 such that air passes through the channel 578, the first trim 528, and toward an environment in which an occupant can be positioned. Depending on the structural arrangement of a seat component and a second ventilation layer, air traveling through a channel can travel through a seat trim and around a first ventilation layer or a first ventilation layer can defined structure that does not obstruct the channel during use. In embodiments in which a second seat component is included in vehicle seat climate system 510 that includes the structure described with respect to the first seat component 520, the vehicle seat climate system 510 can optionally include a ventilation device controller, as described herein, attached to the first ventilation device 514 included on the first seat component 520 and a second ventilation device included on the second seat component.

While FIG. 15 illustrates the first ventilation device 514 as being connected to the first ventilation layer 524 and the second ventilation layer 526 in a particular manner, a ventilation device can be connected to a ventilation layer in any suitable manner. For example, a suction port of a ventilation device can be connected to a foam layer such that suction can be applied to the foam layer. In addition, while FIG. 15 illustrates the first ventilation layer 524 and the second ventilation layer 526 as being positioned at a particular location on the first seat component 520, a ventilation layer can be positioned at any suitable location on a vehicle seat component. For example, a first ventilation layer and a second ventilation layer can alternatively be positioned between a first cushion and a first frame and/or a foam layer can be positioned between a first trim and a first ventilation layer and/or between a first cushion portion and a first ventilation layer.

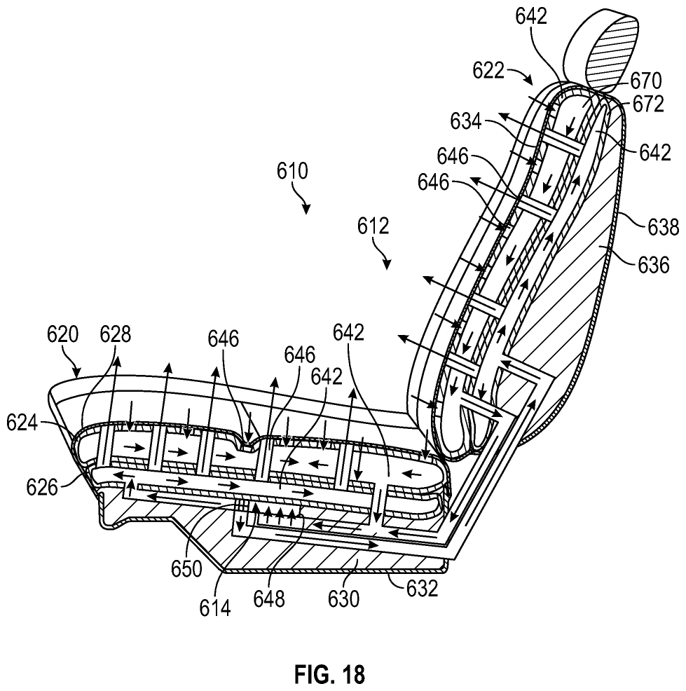

FIG. 18 illustrates a sixth embodiment of a vehicle seat climate system 610 that includes a vehicle seat 612 and a first ventilation device 614.

In the illustrated embodiment, the vehicle seat 612 has a first seat component 620, a second seat component 622, a first ventilation layer 624, a second ventilation layer 626, a third ventilation layer 670, and a fourth ventilation layer 672. The first seat component 620 has a first trim 628, a first cushion portion 630, and a first frame 632. The second seat component 622 has a second trim 634, a second cushion portion 636, and a second frame 638. In the illustrated embodiment, the first ventilation layer 624 and the second ventilation layer 626 are disposed on the first seat component 620 and the third ventilation layer 670 and the fourth ventilation layer 672 are disposed on the second seat component 622. The first ventilation layer 624 and the second ventilation layer 626 are disposed between the first trim 628 and the first cushion portion 630 and the third ventilation layer 670 and the fourth ventilation layer 672 are disposed between the second trim 634 and the second cushion portion 636. The first ventilation layer 624 is isolated from the second ventilation layer 626 and the third ventilation layer 670 is isolated from the fourth ventilation layer 672.

The first ventilation device 614 is connected to the first ventilation layer 624, the second ventilation layer 626, the third ventilation layer 670, and the fourth ventilation layer 672. In the illustrated embodiment, air enters the suction port 648 from the first ventilation layer 624 and the third ventilation layer 670 and the and air exits the discharge port 650 into the second ventilation layer 626 and the fourth ventilation layer 672 when the first ventilation device 614 is in the on state. When the first ventilation device 614 is in the on state, suction is applied to the chamber 642 of the first ventilation layer 624 such that air passes into the chamber 642 of the first ventilation layer 624 from the plurality of openings 646 of the first ventilation layer 624 and into the suction port 648 and suction is applied to the chamber 642 of the third ventilation layer 670 such that air passes into the chamber 642 of the third ventilation layer 670 from the plurality of openings 646 of the third ventilation layer 670 and into the suction port 648. In addition, when the first ventilation device 614 is in the on state, air is blown into the chamber 642 of the second ventilation layer 626 such that air passes through the plurality of openings 646 of the second ventilation layer 626 toward an environment in which an occupant can be positioned and air is blown into the chamber 642 of the fourth ventilation layer 672 such that air passes through the plurality of openings 646 toward an environment in which an occupant can be positioned.

While FIG. 18 illustrates the first ventilation device 614 being connected to the first ventilation layer 624, the second ventilation layer 626, the third ventilation layer 670, and the fourth ventilation layer 672 in a particular manner, a ventilation device can be connected to a ventilation layer in any suitable manner. For example, a suction port of a ventilation device can be connected to a second ventilation layer and/or a fourth ventilation layer such that suction can be applied to the ventilation layers and/or a discharge port of a ventilation device can be connected to a first ventilation layer and/or a third ventilation layer such that air can be blown into the ventilation layers. In addition, while FIG. 18 illustrates the first ventilation layer 624 and the second ventilation layer 626 as being positioned at a particular location on the first seat component 620 and the third ventilation layer 670 and the fourth ventilation layer 672 as being positioned at a particular location on the second seat component 622, a ventilation layer can be positioned at any suitable location on a vehicle seat component. For example, a first ventilation layer and/or a second ventilation layer can alternatively be positioned between a first cushion and a first frame and/or a third ventilation layer and/or a fourth ventilation layer can alternatively be positioned between a second cushion and a second frame.

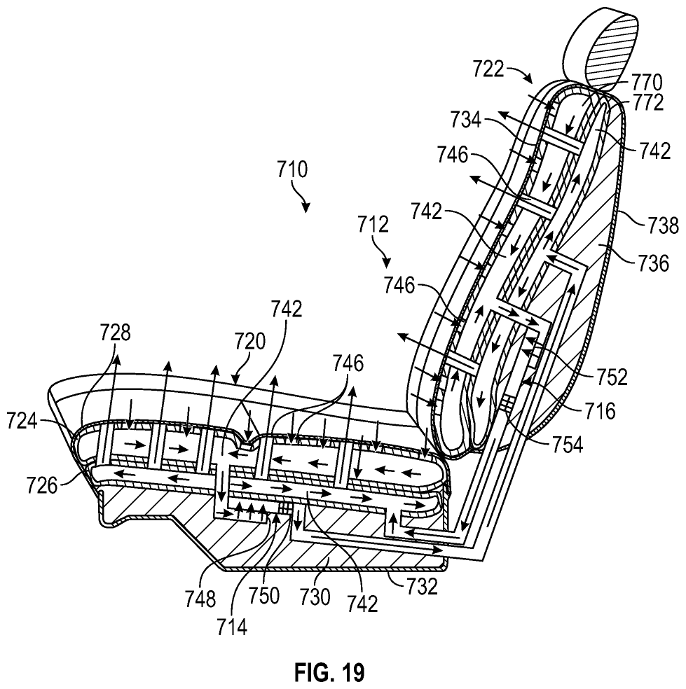

FIG. 19 illustrates a seventh embodiment of a vehicle seat climate system 710 that includes a vehicle seat 712, a first ventilation device 714, and a second ventilation device 716. While not illustrated, the vehicle seat climate system 710 illustrated in FIG. 19 can optionally include a ventilation device controller, as described herein.

In the illustrated embodiment, the vehicle seat 712 has a first seat component 720, a second seat component 722, a first ventilation layer 724, a second ventilation layer 726, a third ventilation layer 770, and a fourth ventilation layer 772. The first seat component 720 has a first trim 728, a first cushion portion 730, and a first frame 732. The second seat component 722 has a second trim 734, a second cushion portion 736, and a second frame 738. In the illustrated embodiment, the first ventilation layer 724 and the second ventilation layer 726 are disposed on the first seat component 720 and the third ventilation layer 770 and the fourth ventilation layer 772 are disposed on the second seat component 722. The first ventilation layer 724 and the second ventilation layer 726 are disposed between the first trim 728 and the first cushion portion 730 and the third ventilation layer 770 and the fourth ventilation layer 772 are disposed between the second trim 734 and the second cushion portion 736.

The first ventilation device 714 is connected to the first ventilation layer 724 and the fourth ventilation layer 772. In the illustrated embodiment, air enters the suction port 748 from the first ventilation layer 724 and air exits the discharge port 750 into the fourth ventilation layer 772 when the first ventilation device 714 is in the on state. When the first ventilation device 714 is in the on state, suction is applied to the chamber 742 of the first ventilation layer 724 such that air passes through the first trim 728, the plurality of openings 746 of the first ventilation layer 724, into the chamber 742 of the first ventilation layer 724, and into the suction port 748. In addition, when the first ventilation device 714 is in the on state, air is blown into the chamber 742 of the fourth ventilation layer 772 such that air passes through the plurality of openings 746 of the fourth ventilation layer 772, the second trim 734, and toward an environment in which an occupant can be positioned.

The second ventilation device 716 is connected to the second ventilation layer 726 and the third ventilation layer 770. In the illustrated embodiment, air enters the suction port 752 from the third ventilation layer 770 and air exits the discharge port 752 into the second ventilation layer 726 when the second ventilation device 716 is in the on state. When the second ventilation device 716 is in the on state, suction is applied to the chamber 742 of the third ventilation layer 770 such that air passes through the second trim 734, the plurality of openings 746 of the third ventilation layer 770, into the chamber 742 of the third ventilation layer 770, and into the suction port 752. In addition, when the second ventilation device 716 is in the on state, air is blown into the chamber 742 of the second ventilation layer 726 such that air passes through the plurality of openings 746 of the second ventilation layer 726, the first trim 728, and toward an environment in which an occupant can be positioned.

While FIG. 19 illustrates the first ventilation device 714 as being connected to the first ventilation layer 724 and the fourth ventilation layer 772 in a particular manner and the second ventilation device 716 as being connected to the second ventilation layer 726 and the third ventilation layer 770 in a particular manner, a ventilation device can be connected to a ventilation layer in any suitable manner. For example, a suction port of a first ventilation device can be connected to a second ventilation layer, a discharge port of the first ventilation device can be connected to a third ventilation layer, a suction port of a second ventilation device can be connected to a fourth ventilation layer, a discharge port of the second ventilation device can be connected to a first ventilation layer. In addition, while FIG. 19 illustrates the first ventilation layer 724 and the second ventilation layer 726 as being positioned at a particular location on the first seat component 720 and the third ventilation layer 770 and the fourth ventilation layer 772 as being positioned at a particular location on the second seat component 722, a ventilation layer can be positioned at any suitable location on a vehicle seat component. For example, a first ventilation layer and/or a second ventilation layer can alternatively be positioned between a first cushion and a first frame and/or a third ventilation layer and/or a fourth ventilation layer can alternatively be positioned between a second cushion and a second frame.

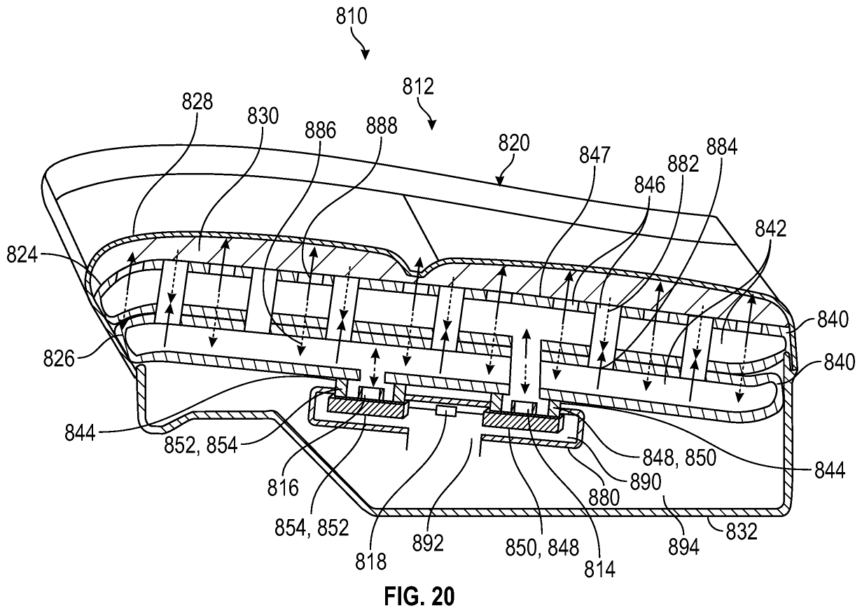

FIG. 20 illustrates an eighth embodiment of a vehicle seat climate system 810 that includes a vehicle seat 812, a first ventilation device 814, a second ventilation device 816, and a ventilation device controller 818. In the illustrated embodiment, the vehicle seat 812 has been illustrated as including a first seat component 820 for clarity. However, a vehicle seat can include a second seat component, as described herein, which can optionally include the structure described with respect to the first seat component 820.

In the embodiment illustrated, the vehicle seat 812 has a first seat component 820, a first ventilation layer 824, a second ventilation layer 826, and an air box 880. The first seat component 820 has a first trim 828, a first cushion portion 830, and a first frame 832. The first ventilation layer 824 and the second ventilation layer 826 are disposed between the first cushion portion 830 and the first frame 832. However in alternative embodiments, a first ventilation layer and a second ventilation layer can be disposed between a first trim and a first cushion portion.

As shown in FIG. 20, each of the first ventilation layer 824 and the second ventilation layer 826 comprises a housing 840 that defines a chamber 842, a port 844, and a plurality of openings 846. The port 844 is in fluid communication with the chamber 842 such that air can pass through the port 844 and into the chamber 842, or vice versa. Each opening of the plurality of openings 846 is also in fluid communication with the chamber 842 such that air can pass through each opening of the plurality of openings 846 and into the chamber 842, or vice versa. Optionally, a spacer material can cover each opening of the plurality of openings 846 of the first ventilation layer 824 and/or the second ventilation layer 826. Alternatively, an air permeable member can be disposed within each opening of the plurality of openings 846 of the first ventilation layer 824 and/or the second ventilation layer 826. As shown in FIG. 20, the plurality of openings 846 of the second ventilation layer 826 is disposed on a surface 847 of the first ventilation layer 824 such that the plurality of openings 846 of the first ventilation layer 824 and the plurality of openings 846 of the second ventilation layer 826 are disposed on the same surface 847. The first ventilation layer 824 is isolated from the second ventilation layer 826. However, alternative embodiments can include ventilation layers that are in direct fluid communication with one another.

The first ventilation device 814 is connected to the first ventilation layer 824. In the illustrated embodiment, the first ventilation device 814 is connected to the port 844 of the first ventilation layer 824. The first ventilation device 814 moves air through the first ventilation layer 824 when in the on state and does not move air through the first ventilation layer 824 when in the off state. The first ventilation device 814 has a suction port 848 and a discharge port 850, which can be positioned in two different locations, as shown in FIG. 20. FIG. 20 illustrates the two alternative positions of the first ventilation device 814 in the vehicle seat climate system 810. In the first position, the first ventilation device 814 is attached to the suction port 848. In the second position, the first ventilation device 814 is attached to the discharge port 850. Depending on whether it is desired to apply suction to the chamber 842 of the first ventilation layer 824 or to blow air into the chamber 842 of the first ventilation layer 824, the first ventilation layer 824 can be connected to the suction port 848 or the discharge port 850 of the first ventilation device 814. When the first ventilation device 814 is in the on state and the first ventilation layer 824 is attached to the suction port 848, air enters the suction port 848 from the first ventilation layer 824 and air exits the discharge port 850 into the air box 880. In this arrangement, when the first ventilation device 814 is in the on state, suction is applied to the chamber 842 of the first ventilation layer 824 such that air passes through the first trim 828, the first cushion portion 830, the plurality of openings 846 of the first ventilation layer 824, into the chamber 842 of the first ventilation layer 824, and into the suction port 848, as shown by arrows 882. When the first ventilation device 814 is in the on state and the first ventilation layer 824 is attached to the discharge port 850, air enters the suction port 848 from the air box 880 and exits the discharge port 850 into the first ventilation layer 824. In this arrangement, when the first ventilation device 814 is in the on state, air is blown into the chamber 842 of the first ventilation layer 814 such that air passes through the plurality of openings 846 of the first ventilation layer 824, the first cushion portion 830, the first trim 828, and toward an environment in which an occupant can be positioned, as shown by arrows 884. In the embodiment illustrated, the first ventilation device 814 does not include a PCBA. Rather, only the components necessary to move air through the first ventilation layer 824 are included in the first ventilation device 814 (e.g., a fan).

The second ventilation device 816 is connected to the second ventilation layer 826. In the illustrated embodiment, the second ventilation device 816 is connected to the port 844 of the second ventilation layer 826. The second ventilation device 816 moves air through the second ventilation layer 826 when in the on state and does not move air through the second ventilation layer 826 when in the off state. The second ventilation device 816 has a suction port 852 and a discharge port 854, which can be positioned in two different locations, as shown in FIG. 20. FIG. 20 illustrates the two alternative positions of the first ventilation device 814 in the vehicle seat climate system 810. In the first position, the second ventilation device 816 is attached to the suction port 852. In the second position, the second ventilation device 816 is attached to the discharge port 854. Depending on whether it is desired to apply suction to the chamber 842 of the second ventilation layer 826 or to blow air into the chamber 842 of the second ventilation layer 826, the second ventilation layer 826 can be connected to the suction port 852 or the discharge port 854 of the second ventilation device 816. When the second ventilation device 816 is in the on state and the second ventilation layer 826 is attached to the suction port 852, air enters the suction port 852 from the second ventilation layer 826 and air exits the discharge port 854 into the air box 880. In this arrangement, when the second ventilation device 816 is in the on state, suction is applied to the chamber 842 of the second ventilation layer 826 such that air passes through the first trim 828, the first cushion portion 830, the plurality of openings 846 of the second ventilation layer 826, into the chamber 842 of the second ventilation layer 826, and into the suction port 852, as shown by arrows 886. When the second ventilation device 816 is in the on state and the second ventilation layer 826 is attached to the discharge port 854, air enters the suction port 852 from the air box 880 and exits the discharge port 854 into the second ventilation layer 826. In this arrangement, when the second ventilation device 816 is in the on state, air is blown into the chamber 842 of the second ventilation layer 826 such that air passes through the plurality of openings 846 of the second ventilation layer 826, the first cushion portion 830, the first trim 828, and toward an environment in which an occupant can be positioned, as shown by arrows 888. In the embodiment illustrated, the second ventilation device 816 does not include a PCBA. Rather, only the components necessary to move air through the second ventilation layer 826 are included in the second ventilation device 816 (e.g., a fan).

Since the first ventilation layer 824 can be attached to either the suction port 848 or the discharge port 850 of the first ventilation device 814 and the second ventilation layer 826 can be attached to either the suction port 852 or the discharge port 854 of the second ventilation device 816, multiple variations of the vehicle seat climate system 810 can be accomplished. A first variation includes attaching the first ventilation layer 824 to the suction port 848 of the first ventilation device 814 and the second ventilation layer 826 to the suction port 852 of the second ventilation device 816. This results in suction being applied to both the first and second ventilation layers 824, 826 when the first and second ventilation devices 814, 816 are in the on state. A second variation includes attaching the first ventilation layer 824 to the suction port 848 of the first ventilation device 814 and the second ventilation layer 826 to the discharge port 854 of the second ventilation device 816. This results in suction being applied to the first ventilation layer 824 and air being blown into the second ventilation layer 826 when the first and second ventilation devices 814, 816 are in the on state. A third variation includes attaching the first ventilation layer 824 to the discharge port 850 of the first ventilation device 814 and the second ventilation layer 826 to the suction port 852 of the second ventilation device 816. This results in air being blown into the first ventilation layer 824 and suction being applied to the second ventilation layer 826 when the first and second ventilation devices 814, 816 are in the on state. A fourth variation includes attaching the first ventilation layer 824 to the discharge port 850 of the first ventilation device 814 and the second ventilation layer 826 to the discharge port 854 of the second ventilation device 816. This results in air being blown into both the first and second ventilation layers 824, 826 when the first and second ventilation devices 814, 816 are in the on state.

The air box 880 defines a chamber 890, an opening 892, and houses the first ventilation device 814 and the second ventilation device 816. The chamber 890 is sized and configured to house a portion, or the entirety, of the first ventilation device 814 and/or the second ventilation device 816. The opening 892 provides fluid access between the chamber 890 and an environment 894 exterior to the air box 880 such that air can be provided to the first and second ventilation devices 824, 816 and moved, as described herein. An air box can define any suitable structure capable of containing a portion, or the entirety, of first and second ventilation devices, a ventilation device controller, and that provides access to an environment exterior to a chamber defined by the air box. While the vehicle seat climate system 810 has been illustrated as including an air box 880, alternative embodiments of a vehicle seat climate system can omit an air box.

The ventilation device controller 818 is similar to the ventilation device controller 118, described above. For example, in the illustrated embodiment, the ventilation device controller 818 is connected to the first ventilation device 814, the second ventilation device 816, and a seat ECU and only the ventilation device controller 818 includes a controller and a driver. Neither of the first ventilation device 814 or the second ventilation device 816 includes a controller 866 or a driver 868. While each of the first ventilation device 814 and the second ventilation device 816 have been illustrated as connected to the ventilation device controller 818, alternative embodiments can omit the inclusion of a ventilation device controller such that each of a first ventilation device and a second ventilation device includes a controller and a driver and is directly connected to a seat ECU. Automation can be established to control a ventilation device such that it can be switched off after a defined period of time or when a desired temperature has been achieved. Automation can also be established to control the speed at which a ventilation device operates (e.g., after a defined period of time or when a desired temperature has been achieved). Any suitable type of automation can be utilized to assist with controlling a ventilation device, or first and second ventilation devices simultaneously or individually. For example, if a first desired temperature has been achieved for a first ventilation device, the first ventilation device can be switched off and the second ventilation device can continue to run to provide air flow until a second desired temperature is reached. This reduces the overall power consumer by a system. As described herein, when two ventilation devices are being utilized, both ventilation devices can be used simultaneously or individually.

An alternative embodiment of a vehicle seat climate system includes only a first ventilation layer with two ports, a first ventilation device, and a second ventilation device. In one example of this alternative embodiment, the suction port of the first ventilation device is attached to a first port of the first ventilation layer and the discharge port of the second ventilation device is attached to a second port of the first ventilation layer. Each of the first and second ventilation devices moves air through the first ventilation layer when in the on state and does not move air through the first ventilation layer when in the off state, as described herein. This structural arrangement allows for the vehicle seat climate system to be used in multiple ways. For example, both of the first and second ventilation devices can be positioned in the on state simultaneously such that suction is applied to the first ventilation layer and air is blown into the first ventilation layer. Alternatively, the first ventilation device can be positioned in the on state such that suction is applied to the first ventilation layer or the second ventilation device can be positioned in the on state such that air is blown into the first ventilation layer. Alternatively, the suction ports of each of the first ventilation device and the second ventilation device can be attached to the first ventilation layer such that suction can be applied to the first ventilation layer by one, or both, of the ventilation devices or the discharge ports of each of the first ventilation device and the second ventilation device can be attached to the first ventilation layer such that air can be blown into the first ventilation layer by one, or both, of the ventilation devices.

Optionally, a ventilation device included in a vehicle seat climate system can include a fan flap cover attached to a suction port and/or a discharge port (e.g., between the ventilation device and a ventilation layer, between the ventilation device and a chamber defined by an air box, between a ventilation device and a frame) to regulate, or prevent, air flow through the ventilation device when the ventilation device is in the on state by moving the fan flap cover between an open configuration and a closed configuration. Any suitable fan flap cover can be utilized in a vehicle seat climate system and selection of a suitable fan flap cover can be based on various considerations, such as the ventilation device included in the vehicle seat climate system. Examples of fan flap covers considered suitable to include in a vehicle seat climate system include control flaps, with or without servomotors, and any other fan flap cover considered suitable for a particular embodiment. For example, in the alternative embodiment in which a first and second ventilation device are connected to a single ventilation layer, a fan flap cover can be position on the discharge port of the first ventilation device and/or the suction port of the second ventilation device to control which ventilation device moves air through the ventilation layer. In instances in which it is desired to move air through the first ventilation layer, each of the first and second ventilation devices can be positioned in the on state and each of the fan flap covers can be positioned in the open configuration such that suction can be applied to the first ventilation layer by the first ventilation device and air can be blown into the first ventilation layer by the second ventilation device. Alternatively, each of the first and second ventilation devices can be positioned in the on state and the fan flap cover attached to the discharge port of the first ventilation device can be positioned in the closed configuration such that the second ventilation device blows air into the first ventilation layer or the fan flap cover attached to the suction port of the second ventilation device can be positioned in the closed configuration such that the first ventilation device applies suction to the first ventilation layer.

The illustration of any component, element, or feature described herein as being disposed above, below, left of, or right of another component, element, or feature is only with reference to the relative location of the components, elements, and features as shown in the figures in order to aid in describing the vehicle seat climate systems. Accordingly, the components, elements, or features illustrated and described herein can be oriented in any manner desired without departing from the spirit or scope of the invention.

Those with ordinary skill in the art will appreciate that various modifications and alternatives for the described and illustrated embodiments can be developed in light of the overall teachings of the disclosure, and that the various elements and features of one example described and illustrated herein can be combined with various elements and features of another example without departing from the scope of the invention. Accordingly, the particular examples disclosed herein have been selected by the inventor(s) simply to describe and illustrate examples of the invention and are not intended to limit the scope of the invention or its protection, which is to be given the full breadth of the appended claims and any and all equivalents thereof.

What is claimed is:

1. A seat climate system comprising:
a seat having a first ventilation layer and a second ventilation layer;
a first ventilation device connected to the first ventilation layer, the first ventilation device having an off state and an on state, the first ventilation device moving air through the first ventilation layer when in the on state;
a second ventilation device connected to the second ventilation layer, the second ventilation device having an off state and an on state, the second ventilation device moving air through the second ventilation layer when in the on state; and
a ventilation device controller connected to the first ventilation device and the second ventilation device, the ventilation device controller including a controller and a driver.

2. The seat climate system of claim 1, wherein the seat comprises a first seat component and a second seat component disposed adjacent to the first seat component;
wherein the first ventilation layer is disposed on the first seat component; and
wherein the second ventilation layer is disposed on the second seat component.

3. The seat climate system of claim 2, wherein the first seat component has a first trim, a first cushion portion, and a first frame; and
wherein the first ventilation layer is disposed between the first trim and the first cushion portion.

4. The seat climate system of claim 2, wherein the second seat component has a second trim, a second cushion portion, and a second frame; and
wherein the second ventilation layer is disposed between the second trim and the second cushion portion.

5. The seat climate system of claim 1, wherein the seat comprises a first seat component and a second seat component disposed adjacent to the first seat component; and
wherein the first ventilation layer and the second ventilation layer are disposed on the first seat component.

6. The seat climate system of claim 5, wherein the first seat component has a first frame, a first trim, and a first cushion portion; and
wherein the first ventilation layer and the second ventilation layer are disposed between the first trim and the first cushion portion.

7. The vehicle seat climate system of claim 5, wherein the first ventilation device has a first suction port and a first discharge port;
wherein the second ventilation device has a second suction port and a second discharge port;
wherein air exits the first discharge port into the first ventilation layer when the first ventilation device is in the on state; and
wherein air enters the second suction port from the second ventilation layer when the second ventilation device is in the on state.

8. The seat climate system of claim 1, wherein the first ventilation device does not include a PCBA.

9. The seat climate system of claim 1, wherein the second ventilation device does not include a PCBA.

10. A seat climate system comprising:
a seat having a first ventilation layer and a second ventilation layer; and
a first ventilation device connected to the first ventilation layer and the second ventilation layer, the first ventilation device having an off state and an on state, the first ventilation device moving air through the first ventilation layer and the second ventilation layer when in the on state.

11. The seat climate system of claim 10, wherein the first ventilation device has a suction port and a discharge port;
wherein air enters the suction port from the first ventilation layer when the first ventilation device is in the on state; and
wherein air exits the discharge port into the second ventilation layer when the first ventilation device is in the on state.

12. The seat climate system of claim 10, wherein the first ventilation layer is isolated from the second ventilation layer.

13. The seat climate system of claim 10, wherein the seat comprises a first seat component and a second seat component disposed adjacent to the first seat component; and
wherein the first ventilation layer and the second ventilation layer are disposed on the first seat component.

14. The seat climate system of claim 13, wherein the first seat component has a first trim, a first cushion portion, and a first frame; and
wherein the first ventilation layer and the second ventilation layer are disposed between the first trim and the first cushion portion.

15. The seat climate system of claim 13, further comprising a third ventilation layer and a fourth ventilation layer disposed on the second seat component; and
further comprising a second ventilation device connected to the third ventilation layer and the fourth ventilation layer such that the second ventilation device moves air through the third ventilation layer and the fourth ventilation layer when in the on state.

16. The seat climate system of claim 15, wherein the second ventilation device has a suction port and a discharge port;
wherein air enters the suction port from the third ventilation layer when the second ventilation device is in the on state; and
wherein air exits the discharge port into the fourth ventilation layer when the second ventilation device is in the on state.

17. The seat climate system of claim 15, further comprising a ventilation device controller connected to the first ventilation device and the second ventilation device, the ventilation device controller including a controller and a driver.

18. The seat climate system of claim 10, wherein one of the first ventilation layer and the second ventilation layer is formed of a foam layer that defines a passageway and a channel.

19. The seat climate system of claim 10, wherein one of the first ventilation layer and the second ventilation layer comprises a housing that defines a chamber, a port, and a plurality of openings.

20. A seat climate system comprising:
a seat having a first ventilation layer, a second ventilation layer, a third ventilation layer, and a fourth ventilation layer;
a first ventilation device connected to the first ventilation layer and the second ventilation layer, the first ventilation device having an on state, an off state, a suction port connected to the first ventilation layer, and a discharge port connected to the second ventilation layer, the first ventilation device moving air through the first ventilation layer and the second ventilation layer when in the on state such that air enters the suction port from the first ventilation layer and air exits the discharge port into the second ventilation layer; and
a second ventilation device connected to the third ventilation layer and the fourth ventilation layer, the second ventilation device having an on state, an off state, a suction port connected to the third ventilation layer, and a discharge port connected to the fourth ventilation layer, the second ventilation device moving air through the third ventilation layer and the fourth ventilation layer when in the on state such that air enters the suction port from the third ventilation layer and air exits the discharge port into the fourth ventilation layer.
